(19) United States
(12) Patent Application Publication
(10) Pub. No.: US 2012/0111139 A1
(43) Pub. Date: May 10, 2012

(54) Camshaft and Corresponding Production Method

(75) Inventors: Johannes TISCH, Achern (DE); Markus Schuler, Oberwolfach (DE)

(73) Assignee: Neumayer Tekfor Holding GmbH, Hausach (DE)

(21) Appl. No.: 13/353,771

(22) Filed: Jan. 19, 2012

Related U.S. Application Data
(63) Continuation of application No. PCT/DE2010/000831, filed on Jul. 19, 2010.

(30) Foreign Application Priority Data
Jul. 21, 2009 (DE) 10 2009 034 024.6

(51) Int. Cl. F16H 53/00; B23P 15/00

(52) U.S. Cl. 74/567; 29/888.1

(57) ABSTRACT

A camshaft comprising a carrier element and at least one cam in which the carrier element is comprised of at least two carrier sections, and a method of manufacturing such a camshaft.

### CROSS REFERENCE TO RELATED APPLICATIONS

This application is a continuation of international patent application no. PCT/DE2010/000831, filed Jul. 19, 2010 designating the United States of America and published in German on Jan. 27, 2011 as WO 2011/009438, the entire disclosure of which is incorporated herein by reference. Priority is claimed based on Federal Republic of Germany patent application no. DE 10 2009 034 024.6, filed Jul. 21, 2009, the entire disclosure of which is likewise incorporated herein by reference.

### BACKGROUND OF THE INVENTION

The present invention relates to a camshaft comprising a single carrier element and at least one cam fabricated separately. Furthermore, the invention relates to a method for the fabrication of a camshaft comprising a single carrier element and at least one cam fabricated separately.

US patent publication no. 2004/0134063 (=DE 101 01 539) describes a method for fabricating cam shafts. In this method, the carrier element is stretched and the cams are slid upon the stretched carrier element.

U.S. Pat. No. 6,804,884 (=WO 2001/012956) proposes another method for fabrication.

According to the prior art, smaller engines typically have one-piece camshafts while the shafts of larger engines frequently consist of multiple segments. U.S. Pat. No. 5,979,386 (=EP 812,379) describes a camshaft having an integral inner shaft tube encompassed by an array of interconnected tube segments, sections of which are formed as cams.

U.S. Pat. No. 5,664,463 (=DE 43 06 621) and US patent publication no. 2007/074685 (=DE 10 2004 009 074) disclose similar designs. They each comprise an integral inner shaft around which a carrier is provided, parts of which have the contour of cams.

German utility model no. DE 20 2005 021 511 U1 describes a camshaft that is composed of multiple segments. Sections of these segments comprise a cam geometry and can be connected to one another by coupling elements.

The camshaft of published international patent application no. WO 2009/056237 consists of elements that have corresponding outer contours and can be moved relative to one another.

The disadvantage of prior art is that the shafts often have a complex outer shape. In addition, the segments often have only a small contact area so that connections are not always stable and reliable. It is furthermore frequently required that the function-related elements—such as the cams—have to be reworked after they have been attached to the tube. The devices of the prior art therefore typically involve a major processing effort and high costs. Also, an integral inner shaft is required for stability.

### SUMMARY OF THE INVENTION

It is therefore the object of this invention to provide a camshaft and a corresponding production method that overcome the disadvantages of prior art.

According to the invention, this object is achieved with respect to the camshaft in that the carrier element is comprised of at least two firmly connected carrier sections that are axially arranged behind one another. The carrier element is also referred to as a carrier shaft or tube. According to the invention, the shaft that in use typically rotates about an axis is comprised of multiple carrier elements that are firmly connected to one another. The carrier sections may for example be connected by a press fit. The carrier sections may alternatively or additionally be welded, soldered, or glued together. The term axially in particular refers to the axis about which the camshaft rotates when installed.

In one embodiment, the carrier sections comprise a substantially smooth outer contour, and in a complementary or alternative embodiment the carrier sections comprise varying outer diameters from section to section. Such a camshaft is used, for example, in truck engines. The cams of the camshaft according to the invention are therefore mounted onto a single carrier element, i.e., onto a shaft, and not, for example, onto a shaft that houses yet another one-piece shaft. The carrier element of the invention as the sole or only shaft of the camshaft according to the invention has a multi-part design in that it is comprised of at least two separate carrier sections. Furthermore, the functional elements on this multi-part shaft are separately fabricated cams. The cam is therefore not a component of the carrier element or its sections.

In one embodiment of the camshaft according to the invention, at least one of the at least two carrier sections has a substantially tubular construction. In one embodiment, all carrier sections have a substantially tubular structure. In an embodiment especially comprising carrier sections with a smooth outer contour, the carrier element can be fabricated very easily and cost-efficiently. In one embodiment of the camshaft according to the invention, at least one of the at least two carrier sections is at least partially hollow. Depending on the design, the carrier sections may consist of identical or different materials. In one embodiment, at least almost all carrier sections are of identical construction.

In another embodiment of the camshaft according to the invention, at least two of the at least two carrier sections are constructed so as to be adapted or mated to one another such that the one of the at least two carrier sections is at least partially arranged in the other carrier section. The carrier sections are partially inserted into one another in this embodiment. The length of the overlapping region may be, for example, between (0.5 and 1) times the diameter of the carrier section, or it may be at least 10% of the length of one carrier section.

In one other embodiment of the camshaft according to the invention, the one of the at least two carrier sections comprises a widening at its end region, and an end region of the other carrier section is inserted into said widening. Such a widening is a region of a carrier section that has a larger outer diameter than the remaining carrier section.

In one embodiment, the carrier element that is comprised of the carrier sections has substantially the same uniform outer diameter. In another embodiment, there are bulges or expansions with a larger outer diameter in certain sections. This applies in particular to overlap regions of the individual carrier sections.

In one embodiment of the camshaft according to the invention, at least one functional element is provided which applies a radially inward acting force at least in the region of the connection between two carrier sections. Such a functional element may, for example, support or reinforce the connection between individual carrier sections. In an embodiment of the camshaft according to the invention, the at least one functional element is arranged in that area in which one carrier section is partially arranged inside another carrier section. The functional element may thus be located, for example, along the axis about which the installed camshaft rotates, at the level of a connection between two carrier sections. Thus the functional element has a reinforcing effect on the joint of the two carrier sections or the functional element has a more stable underbelly as compared to just one carrier tube.

In one embodiment of the embodiment according to the invention, the at least one functional element is—yet—another cam or a bearing element.

In another embodiment of the camshaft according to the invention, the at least one separately fabricated cam is a prefabricated cam. This embodiment is therefore intended for the use of finished cams. It is preferred that all cams of the camshaft are finished. This means that after the cams are placed on, and attached to, the carrier element, substantially no further processing steps on the cams will be required. This applies likewise to additional elements such as bearings.

The invention furthermore achieves the object with respect to a method for manufacturing a camshaft in that a carrier element is produced by firmly connecting at least two carrier sections to one another. What has been said above about the camshaft applies correspondingly to the method according to the invention and the following embodiments, and vice versa. The at least two carrier sections are in particular locked to one another. In one embodiment, the at least two carrier sections are connected to one another by a press fit. Alternatives or additions to the connection have been mentioned above.

In one embodiment of the method according to the invention, one carrier section is at least partially inserted into another carrier section. In one embodiment of the method according to the invention, an end region of a carrier section is widened and the end region of another carrier element is inserted into the widening of said carrier section. In another embodiment of the method according to the invention, an end region of a carrier section is tapered or narrowed and the tapered or narrowed end region of the carrier element is inserted into the end region of another carrier section.

In another embodiment of the method according to the invention, at least two of the at least two carrier sections are connected to one another such that the connected carrier sections have substantially the same outer diameter. In this embodiment, the carrier sections are connected to one another or at least partially processed or fabricated to fit before being connected such that substantially no protuberances occur but a substantially smooth outer contour and only a single uniform outer diameter of the carrier sections connected to one another is achieved.

In yet another embodiment of the method according to the invention, the at least the one separately fabricated cam—i.e., the cam fabricated or produced separately from the carrier element—Is arranged on at least one of the at least two carrier sections before the carrier section is connected to at least one other carrier section. In another embodiment, this substantially applies to all carrier sections, which have substantially the same structure. Methods for applying cams, especially already finished cams, are described in US 2004/0134063 and U.S. Pat. No. 6,804,884, as noted above, the entire disclosures of which are incorporated herein by reference.

In one embodiment of the method according to the invention, at least one functional element is applied to the carrier element such that said functional element applies a radially inward acting force to the carrier element. In one embodiment of the method according to the invention, the functional element is applied in the area of a connection of two carrier sections.

In another embodiment of the method according to the invention, the at least one cam is substantially finished before it is applied to the carrier element. In one embodiment of the method according to the invention, all processing steps required for the carrier element are performed before the cams or any other elements to be applied, such as bearings, are applied.

In yet another embodiment, the method according to the invention can therefore be described as follows: The carrier sections are connected to one another, and the carrier element is finished. Then the cams and other elements are applied and secured to the carrier element. It is preferred that the cams and other elements are finished before they are applied. In an alternative embodiment, the associated cams or other elements, respectively, are applied to each carrier section, and the carrier sections “equipped” in this way are then connected to one another. The carrier element composed of the individual carrier sections is thus the only shaft of the camshaft according to the invention.

### BRIEF DESCRIPTION OF THE DRAWINGS

The invention will be described in further detail hereinafter with reference to illustrative embodiments shown in the accompanying drawing figures, in which:

FIG. 1 is a cross-section of a first embodiment of a camshaft according to the invention;

FIG. 2 is a cross-section of a second embodiment of a camshaft according to the invention, and

FIG. 3 is a cross-section of a third embodiment of a camshaft according to the invention.

### DETAILED DESCRIPTION OF ILLUSTRATIVE EMBODIMENTS

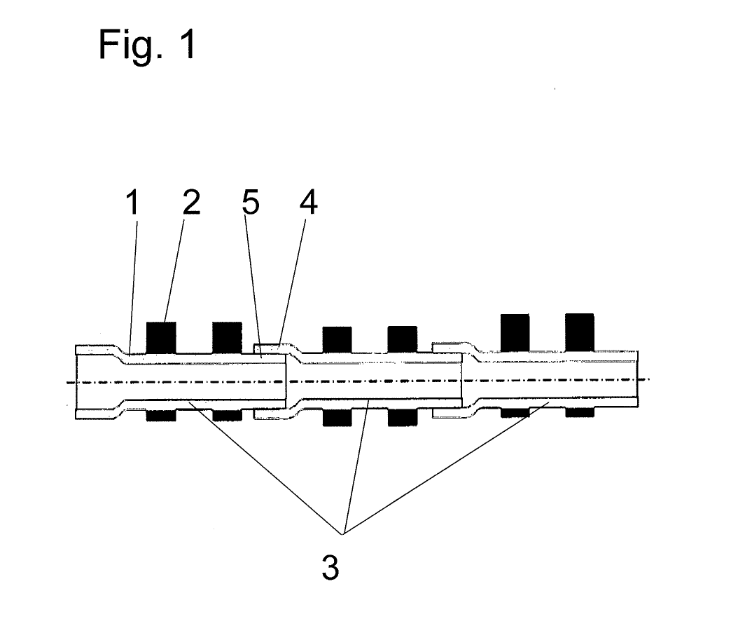

FIG. 1 shows a cross-section of a first embodiment of a camshaft according to the invention. It is comprised of a single carrier element 1, a so-called shaft, which is substantially constructed as a hollow tube, and the individual cams 2 fabricated separately from the carrier element 1. The figure also shows the axis about which the camshaft rotates when installed. The carrier element 1 is comprised of three carrier sections 3, each comprising a widening 4 at one end while their respective other end region 5 is arranged in the widening 4 of another carrier section 3 and attached therein, for example, by a press fit. The carrier sections 3 preferably have a smooth, no-profile outer structure to make the fabrication of the carrier sections 3 as easy as possible. The widenings 4 entail a larger outer diameter for the carrier sections 3. Two cams 2 are provided in each area of the carrier sections 3 with a smaller outer diameter.

It is preferred that the cams 2 are finished when the camshaft is fabricated, such that substantially no additional processing steps are required after the cams 2 are attached to the carrier element 1. This relates, for example, to curing, applying coatings, other modifications of the surface or surface contour of the cams 2. In particular, no more grinding of the cams will be required after they have been attached to the carrier element. This applies likewise to additional functional elements such as bearings.

In one embodiment, the cams 2 or other elements are first applied to the carrier sections 3, and only then are the equipped carrier sections 3 connected to one another. This is particularly advantageous for the case shown in FIG. 1 in which the inner diameters of the cams 2 are smaller than the outer diameters of the widenings 4.

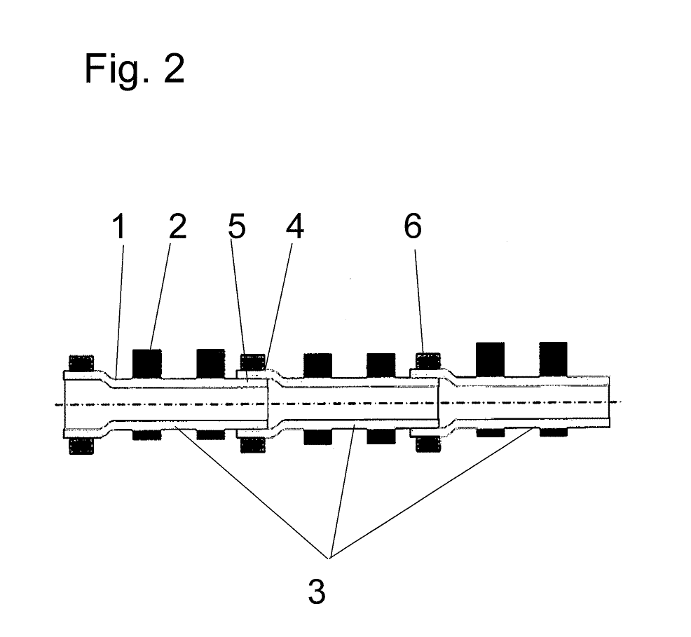

The difference between the embodiments shown in FIG. 1 and FIG. 2 is that a functional element 6 is arranged in the overlap region between two carrier sections 3 in the embodiment shown in FIG. 2. These elements may, for example, be bearings. In one embodiment, the functional elements 6 are constructed and attached such that they apply a radially inward acting force and thereby support the connection between two carrier sections 3.

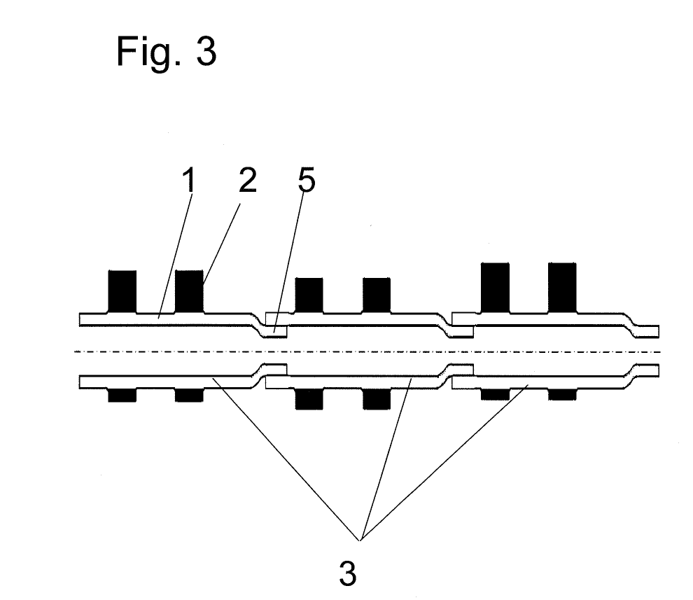

The carrier element 1 shown in FIG. 3 comprises a smoother contour in that an end region 5 of a carrier section 3 is first narrowed or tapered and then inserted into the end region of another carrier section 3. In this way, this embodiment does not comprise the protuberances which result from the widenings as shown in FIGS. 1 and 2. However, in this type of connection, at least one functional element—as shown in FIG. 2—may also be applied accordingly in the overlap regions of the carrier sections 3 that supports the connection or itself is given a stronger support. The types of connection of carrier sections 3 shown in FIG. 1, FIG. 2, and FIG. 3 may also be combined with one another, i.e., the sections 3 may be partially widened and partially narrowed.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. A camshaft comprising
a single carrier element, and
at least one cam fabricated separately;
wherein
the carrier element is comprised of at least two firmly connected carrier sections that are axially arranged behind one another.

2. The camshaft according to claim 1, wherein at least two of the at least two carrier sections are constructed and matched to one another such that the one of the at least two carrier sections is partially arranged in the other carrier section.

3. The camshaft according to claim 2, wherein the said other carrier section comprises a widening at an axial end region thereof, and an axial end region of said one carrier section is inserted into said widening.

4. The camshaft according to claim 1, wherein at least one functional element is provided which applies a radially inward acting force, at least in the region of the connection between the two carrier sections.

5. The camshaft according to claim 2, wherein at least one functional element which applies a radially inward acting force is arranged in a region in which said one carrier section is partially arranged inside the other carrier section.

6. A method for producing a camshaft comprising a single carrier element and at least one cam fabricated separately, wherein said carrier element is produced by firmly connecting at least two carrier sections to one another.

7. The method according to claim 6, wherein an end region of one carrier section is widened, and an end region of another carrier element is inserted into the widening of said one carrier section.

8. The method according to claim 6, wherein an end region of one carrier section is tapered, and the tapered end region of said one carrier section is inserted into an end region of another carrier section.

9. The method according to claim 6, wherein at least two of the carrier sections are connected to one another such that the connected carrier sections have substantially the same outer diameter.

10. The method according to claim 6, wherein said at least one cam is arranged on one of the carrier sections before said one carrier section is connected to at least one other carrier section.
